(19) United States
(12) Patent Application Publication
(10) Pub. No.: US 2011/0003079 A1
(43) Pub. Date: Jan. 6, 2011

(54) PROCESSES FOR PREPARING COATED PAPERS

(76) Inventors: Takehiro Yoshimatsu, Tokyo (JP); Yuji Abe, Tokyo (JP); Daisuke Sakakibara, Tokyo (JP); Hironori Asano, Miyagi (JP)

Correspondence Address: NIXON & VANDERHYE, PC, 901 NORTH GLEBE ROAD, 11TH FLOOR, ARLINGTON, VA, 22203, US

(21) Appl. No.: 12/920,960

(22) PCT Filed: Feb. 4, 2009
(86) PCT No.: PCT/JP2009/051879

§ 371 Date: Sep. 3, 2010

(30) Foreign Application Priority Data
Mar. 21, 2008 (JP) 2008-072810

(51) Int. Cl. B05D 3/12; B05D 3/02

(52) U.S. Cl. 427/361

(57) ABSTRACT

An object of the present invention is to provide a process for preparing a high-quality coated paper with high runnability while preventing damage to the elastic roll surface of the soft calender encountered during high-speed operation. The present invention provides a process for preparing a coated paper, comprising the steps of: making a base paper; applying a coating solution containing a pigment and an adhesive on the base paper to form one or more pigment coating layers; and surface-treating the pigment coating layers by a soft calender, said papermaking and coating steps being performed at an operating speed of 1300 m/min; wherein said surface-treating step comprises treating the outermost one of the pigment coating layers using a soft calender comprising a metallic roll and an elastic roll with at least two or more nips and wherein the elastic roll has a Shore D hardness of 90-96 and the metallic roll surface temperature at the first nip is less than 130° C.

### TECHNICAL FIELD

The present invention relates to processes for preparing coated papers. Especially, the present invention relates to processes for preparing coated papers comprising applying a coating solution containing a pigment and an adhesive on a base paper and calendering the coated web by soft calendering, whereby affording coated printing papers having a good surface appearance including low gloss micro-unevenness and low ink adhesion unevenness.

### BACKGROUND ART

Recently, there has been a growing demand for coated printing papers in the field of commercial printing for advertising purposes such as advertising leaflets, catalogs, pamphlets, direct mails, etc. It would be desirable to provide these commercial prints with high finished print quality at low cost because it is important to achieve their purposes as advertising media though their own commercial value is low. In order to meet such a strong demand for coated papers, paper manufacturers are attempting to increase the width and speed of their coating equipment to increase productivity and reduce costs while keeping high quality. Thus, an important technical challenge in coated printing papers is to increase productivity while keeping high quality.

Generally, one possible solution to cost reduction from the aspect of manufacturing formulations is to decrease the coating mass, which inevitably compromises sheet gloss, surface quality such as smoothness, and printability. Another possible solution is to include a large amount of inexpensive calcium carbonate into the pigment coating solution, but when the proportion exceeds a certain level, sheet gloss and smoothness become unsatisfactory due to the low pigment orientation. Attempts to adopt multilayer coating systems were also made for the purpose of improving base paper coverage to achieve cost reduction and quality improvement at the same time by applying a precoating solution containing an inexpensive pigment.

A means to improve productivity from the aspect of equipment is soft calendering at high temperatures. This intends to dramatically increase productivity by soft calendering at high temperatures on-line directly after applying a pigment using a coater.

Previously, papers coated with a pigment using various coating machines (hereinafter referred to as coaters) were taken up on reels and then passed through a supercalender at a low temperature (about 50-70° C.) under multinip conditions of typically 10-14 nips to confer gloss, thereby giving finished products. However, cotton rolls used in conventional supercalenders are poor in heat resistance due to internal heat generation and also poor in pressure resistance and durability, which imposes a limitation on speedups, e.g., the currently attainable maximum speed is limited to about 800 m/min. Thus, two supercalenders are required to be combined with recent coaters at speeds exceeding 1000 m/min, resulting in further problems in energy- and space-saving.

In contrast, soft calenders including plastic elastic rolls having good resistance to heat and pressure allow for operation even at speeds exceeding 1000 m/min and can be provided on-line on coaters, thereby improving productivity. They also can operate with a smaller number of nips at higher temperatures, which contributes to space-saving and quality to provide bulky (low density) and stiff papers having improved sheet gloss, surface quality such as smoothness and printability because the mirror surfaces of metallic rolls are transferred to paper surfaces while only the outermost paper surfaces are plasticized by high temperatures.

However, treatments at excessively high temperatures compromise appearance because gloss micro-unevenness tends to appear as a result of basis weight unevenness of base paper, coating mass unevenness, pigment orientation unevenness and the like as the operation temperature of the soft calender increases.

In order to solve this problem, a method was proposed to improve trapping unevenness presumed to result from gloss unevenness by mild steam exposure immediately before soft calendering at high temperatures (patent document 1). However, satisfactory improvements in gloss micro-unevenness have not been achieved.

Another method was proposed to improve gloss micro-unevenness by using a top coating pigment solution containing a limited amount of calcium carbonate together with a specific latex and using a soft calender including an elastic roll having a Shore D hardness of 84-90 at a high metallic roll temperature of 130° C. or more (patent document 2). However, this method required improvements to cover recent attempts to attain finished products using an on-machine coater as a production facility at higher speed to further improve productivity because the elastic roll hardness used in this method was insufficient to resist damage to elastic roll surfaces and the like at higher operating speeds of 1300 m/min or more, and especially when web breaks or the like occur, elastic rolls are considerably damaged and should be frequently changed so that excessive spare rolls must be prepared, thereby increasing costs. If an elastic roll having a hardness higher than 90 was used when runnability was paramount, however, convex regions of coated webs were flattened by the hard roll, which led to gloss micro-unevenness.

Another means to improve productivity from the aspect of equipment is to perform the coating step using an on-machine coater. Conventional methods for producing coated papers include the off-machine coating method involving separate steps of papermaking and coating and the on-machine coating method combining papermaking and coating steps in a single machine, and the on-machine coating method is characterized in that the manufacturing costs of products can be reduced so that price competitive products can be produced.

Recently, attempts have been made to afford finished products in an on-machine coater at higher speed in order to further improve productivity. Typical on-machine coaters are film transfer type coaters such as gate roll coaters or rod metering size press coaters, and it would be normally desirable to apply a pigment coating solution containing a pigment and an adhesive using these coaters to give lightweight coated papers or coated papers, or to further apply a pigment coating solution on these coated papers using a blade coater to prepare double coated papers at high speed. Rod metering size press coaters have been preferably used because they avoid the problem of boiling, though the film transfer method has the disadvantage that mist generation and boiling are likely to occur during high-speed operation (patent documents 3-5).

However, if such a pigment coating solution was applied with an on-machine coater at higher speed, applicator roll surfaces were rapidly damaged and the smoothness of the surface of coated paper was impaired, which necessitated roll changes and sometimes compromised runnability. Various methods for preparing coated papers with good surface smoothness and printability by applying a pigment coating with a film transfer type rod metering size press coater have previously been proposed (patent documents 6-10). However, these methods were insufficient to resist damage to applicator roll surfaces and the like especially at operating speeds of 1300 m/min or more, and needed further improvements.

Patent document 1: JPA HEI-4-370298.

Patent document 2: Japanese Patent No. 3082188.

Patent document 3: JPA HEI-10-46496.

Patent document 4: JPA HEI-9-324395.

Patent document 5: JPA HEI-9-170195.

Patent document 6: JPA 2001-115394.

Patent document 7: JPA 2004-332171.

Patent document 8: JPA 2006-328595.

Patent document 9: JPA 2007-46218.

Patent document 10: JPA 2007-63737.

### DISCLOSURE OF THE INVENTION

### Problems to be Solved by the Invention

Under these circumstances, an object of the present invention is to provide a process for preparing a coated paper, comprising applying a coating solution containing a pigment and an adhesive on a base paper followed by calendering through a hot soft calender, which process prevents damage to the elastic roll surface of the soft calender encountered during high-speed operation to prepare a coated paper having a good surface appearance including low gloss micro-unevenness and low ink adhesion unevenness with good runnability.

Another object of the present invention is to provide a process for preparing a coated printing paper having good surface quality with good runnability by preventing damage to applicator roll surfaces encountered when a coating solution containing a pigment and an adhesive is applied at high speed using a rod metering size press type coater.

When a clear coating solution containing a starch or the like was optionally applied using such a rod metering size press coater as described above at a machine speed of 1300 m/min or more especially for preparing a coated paper of low basis weight, mist generation compromised runnability. Thus, another object of the present invention is to improve runnability problems encountered during the step of applying a clear coating solution under high-speed conditions, especially at 1300 m/min or more using a rod metering size press type coater, and therefore, to provide a process for preparing a coated printing paper having high quality after top coating as well as the coated paper.

### Means for Solving the Problems

As a result of careful studies, we achieved the present invention on the basis of the finding that coated papers having a good surface appearance including low gloss micro-unevenness and low ink adhesion unevenness can be obtained while preventing damage to elastic roll surfaces during high-speed operation to improve runnability by adopting a process for preparing a coated paper comprising making a base paper, applying a coating solution containing a pigment and an adhesive on the base paper and drying it to form one or more coating layers followed by a surface treatment with a soft calender, wherein a coated web is obtained at an operating speed of 1300 m/min or more and then the outermost surface layer of the coated web is surface-treated through a soft calender comprising a metallic roll and an elastic roll with at least two or more nips and wherein the elastic roll has Shore hardness of D90-96 and the metallic roll surface temperature at the first nip is less than 130° C.

In the present invention, coated papers having a good sheet gloss and a good surface appearance including low gloss micro-unevenness and low ink adhesion unevenness can be obtained with good runnability by the treatment at a metallic roll surface temperature at the first nip of less than 130° C. Moreover, the surface quality becomes better and the sheet gloss is improved, and the gloss micro-unevenness, ink adhesion unevenness and roughening can be further reduced by preparing the base paper using a gap former type paper machine.

As a result of careful studies, we also succeeded in obtaining good coated printing papers having improved surface quality and the like while preventing damage to applicator roll surfaces during high-speed operation by adopting a process for preparing a coated paper, comprising making a base paper by a paper machine, applying a coating solution containing a pigment and an adhesive on the base paper and drying it to form one or more coating layers, wherein the papermaking and coating speeds are 1300 m/min or more, and wherein the coating solution containing a pigment and an adhesive is applied at 5.0 g/m² or more in total on both sides using a rod metering size press type coater including an applicator roll having a cover material of type A durometer hardness of 89 or more and 95 or less as defined in JISK6253, preferably an on-machine coater. We also succeeded in obtaining coated printing papers having good surface quality and the like while preventing damage to applicator roll surfaces during high-speed operation by further applying a coating solution containing a pigment and an adhesive as a top coating on the coated paper. In the present invention, sheet appearance is improved by applying a coating solution containing 50 parts by weight or more of calcium carbonate as a pigment component per 100 parts by weight of the pigment and 10 parts by weight or more of a starch as a part or the whole of the adhesive per 100 parts by weight of the pigment using the rod metering size press coater, and especially, damage to applicator roll surfaces becomes less likely to occur and sheet appearance and the like are improved by using calcium carbonate having a mean particle size of 0.1 μm or more and 0.8 μm or less. Furthermore, damage to applicator roll surfaces also becomes less likely to occur and surface quality can be improved by using a rod having a groove of 0.30 mm or less in width including an ungrooved rod in the rod metering size press coater. In the present invention, surface quality is improved and roughening can be further inhibited by making the base paper using a roll and blade gap former type paper machine including a drainage mechanism consisting of a drainage blade immediately downstream of initial drainage through a forming roll. Blister resistance can be improved by providing the gap former type paper machine with one or more tandem shoe presses.

We also succeeded in inhibiting boiling and the like problems to prepare coated papers with high runnability by selecting a papermaking speed of 1300 m/min or more, applying a starch coating solution as a precoating at 0.5 g/m² or more on both sides using a rod metering size press type coater including a rod having a groove of 0.30 mm in width or less, and further applying a coating solution containing a pigment and an adhesive.

### Advantages of the Invention

According to the present invention, coated papers having a good surface appearance including low gloss micro-unevenness, low ink adhesion unevenness and good sheet gloss can be obtained by a process comprising applying a coating solution containing a pigment and an adhesive on a base paper followed by soft calendering, which process prevents damage to the elastic roll surface of the soft calender to improve high-speed runnability.

According to the present invention, processes for preparing a coated printing paper with good surface quality and sheet appearance can also be obtained while improving high-speed runnability problems encountered during the step of applying a coating solution containing a pigment and an adhesive using a rod metering size press type coater.

According to the present invention, coated papers for offset printing with high quality such as blister resistance and processes for preparing them can also be obtained while improving runnability problems encountered during the step of applying a coating solution under high-speed conditions using a rod metering size press type coater.

### Preferred Embodiments of the Invention

The present invention provides a process for preparing a coated paper comprising making a base paper, applying a coating solution containing a pigment and an adhesive on the base paper to form one or more coating layers followed by soft calendering, wherein a coated web is obtained at an operating speed of 1300 m/min or more and then the outermost surface of the coated web is surface-treated using a soft calender comprising a metallic roll and an elastic roll with at least two or more nips and wherein the elastic roll has Shore hardness of D90-96 and the metallic roll surface temperature at the first nip is less than 130° C.

In the present invention, therefore, a base paper is made and a coating solution containing a pigment and an adhesive is applied on the base paper to form one or more coating layers followed by soft calendering.

Coating Base Papers

Pulp raw materials for coating base papers are not specifically limited, but may be those conventionally used as papermaking raw materials for printing papers such as mechanical pulp (MP), deinked pulp (DIP), hardwood kraft pulp (LKP), softwood kraft pulp (NKP), etc., which may be used alone or optionally as a mixture of two or more of them. Mechanical pulps include groundwood pulp (GP), refiner groundwood pulp (RGP), thermomechanical pulp (TMP), chemithermomechanical pulp (CTMP), chemigroundwood pulp (CGP), semichemical pulp (SCP), etc. Deinked pulp is not specifically limited, and may be derived from sorted waste papers such as woodfree papers, mechanical papers, groundwood papers, news, advertising leaflets and magazines or unsorted waste papers including mixtures of these papers. The present invention can provide advantages such as indifference between both sides of paper and interlayer strength even if the proportion of deinked pulp in the pulp composition is 20% by weight or more, or even 30% by weight or more. In terms of strength, the proportion of deinked pulp is preferably 80% by weight or less.

In the present invention, known fillers can be used. For example, inorganic fillers such as ground calcium carbonate, precipitated calcium carbonate, clay, silica, precipitated calcium carbonate-silica complexes, kaolin, calcined kaolin, delaminated kaolin, magnesium carbonate, barium carbonate, barium sulfate, aluminum hydroxide, calcium hydroxide, magnesium hydroxide, zinc hydroxide, zinc oxide, titanium oxide and amorphous silica prepared by neutralization of sodium silicate with mineral acids, and organic fillers such as urea-formalin resins, melamine resins, polystyrene resins and phenol resins can be used alone or in combination. Among them, typical fillers in neutral and alkaline papermaking such as calcium carbonate and precipitated calcium carbonate-silica complexes are preferably used. The filler content in paper is 1-40% solids by weight. As the filler content in paper increases, the retention decreases. Thus, advantages of the present invention are more remarkable when it is applied to the preparation of base papers for coated printing papers having higher filler contents. From this aspect, the filler content in paper is preferably 10-40% solids by weight, more preferably 12-35% solids by weight.

In the present invention, internal chemicals such as dry strength aids, wet strength aids, freeness improvers, dyes and sizing agents may be optionally used. Dry strength aids include polyacrylamide and cationized starch, while wet strength aids include polyamide amine epichlorohydrin, etc. These chemicals are added without affecting formation and runnability, etc. Neutral sizing agents include alkyl ketene dimers, alkenyl succinic anhydride, neutral rosin sizing agents, etc. These internal chemicals can be optionally used with pulp and fillers to prepare a stock.

In the preparation of coating base papers of the present invention, conventional paper machines having a former part such as an on-top former, gap former, etc. can be used. Especially in the present invention, gap former type paper machines are preferably used in which a stock delivered from the headbox runs between two wire cloths so that a wet web is dewatered nearly equally from both sides, and especially roll and blade gap former type paper machines including a drainage mechanism consisting of a drainage blade immediately downstream of initial drainage through a forming roll are more suitable at high machine speeds of 1300 m/min or more because they afford papers having good surface quality with little difference between both sides. In roll and blade gap formers, initial drainage takes place in the lap area of a forming roll having a vacuum box immediately followed by blade drainage through a pressure blade module. This mechanism allows for slower drainage than obtained by conventional formers so that papers having a more uniform paper layer structure or formation can be obtained. The forming roll used here desirably has a diameter of 1500 mm or more because a sufficient wrap angle for effective drainage control cannot be obtained if the diameter is small. Dryness can be controlled by optionally using a drainage apparatus such as a suction unit or high-vacuum suction box in addition to and downstream of the drainage mechanism consisting of a forming roll or blade.

The paper machine used in the present invention preferably includes a shoe press in the press part, preferably one or more tandem type shoe presses, more preferably two or more such presses in view of the resulting moisture to improve interlayer strength and blister resistance when the machine speed is high. The shoe press of the present invention may have a nip width of about 150-250 mm, and may be a type in which a web is passed between a rotating press roll and a hydraulically lifted press shoe with a sleeve running between the felt and the press shoe. The pressure of the press can be appropriately controlled allowing for the moisture at the exit of the press and the difference between both sides of paper, preferably at 100 kN/m-1100 kN/m, more preferably 500 kN/m-1100 kN/m.

When two or more of the shoe press are used, web breaks and other problems are reduced and high-speed runnability is improved by passing the web in such a manner that the transfer belt comes into contact with the shoe press on the side of the dryer part.

In the present invention, conventional pre-dryers and after-dryers can also be used, and drying conditions are not specifically limited, either, and can be appropriately defined within the range of conventional operation.

Precoating (Clear Coating)

The coating base paper of the present invention can be prepared from a formulated stock as described above. The coating base paper of the present invention can be optionally surface-treated with a clear coating solution based on an adhesive such as a starch, whereby not only the surface quality of the coating base paper can be improved but also the interlayer strength can be improved by adhesive penetration.

The amount of the adhesive in the clear coating layer is preferably 80% by weight or more based on solids weight, and the coating mass of the clear coating layer is preferably 0.5-3.0 g/m² based on solids weight. Adhesives used as major components of the clear coating solution include native starches and modified starches such as oxidized starches, esterified starches, cationized starches, enzyme-modified starches, aldehyde starches, etherified starches (wet fragmented hydroxyethyl etherified starches, dry fragmented hydroxyethyl etherified starches, etc.), and ionic polyacrylamide, carboxymethyl cellulose, polyvinyl alcohol, etc. In addition to the adhesives, the clear coating solution may also contain sizing agents, surfactants, moisturizers, antifoamers, etc.

Coaters that can be used in the present invention include rod metering size press coaters, blade metering size press coaters, gate roll coaters, and two-roll size press coaters, among which rod metering size press coaters are preferably used especially from the aspect of improving interlayer strength during high-speed operation.

In a preferred embodiment of the present invention, a clear coating solution containing an adhesive such as a starch can be applied by using a rod metering size press (RMSP) coater. As described above, a problem of mist generation was encountered when a paper was prepared at a high machine speed of 1300 m/min or more and coated with a relatively large amount of a clear coating solution using an on-machine water. In order to solve this problem, the shape of the rod was thoroughly investigated to find that no mist occurs, which prevents sheet breaks, reduces dry load and improves runnability, by using a rod having a groove of 0.30 mm or less in width or an ungrooved rod (plain rod) when a clear coating solution is applied at 0.5 g/m² or more in total on both sides under high-speed conditions at a machine speed of 1300 m/min or more.

These mechanisms are not completely explained, but it is presumed that mist generation becomes negligible when a rod having a small groove width is used because the thickness of the coating formed on applicator rolls is so small that the coating on the applicator rolls is almost totally transferred to the base paper. It is presumed that if the groove width is large, however, the thickness of the coating formed on applicator rolls is so large that the coating is not totally transferred to the base paper and contributes to mist generation.

In the present invention, a rod having a groove of 0.30 mm or less in width or an ungrooved rod (plain rod) is preferably used in the RMSP. Especially, the groove width of the rod is preferably 0.05-0.30 mm, more preferably 0.05-0.20 mm, still more preferably 0.05-0.15 mm, in terms of mist inhibition, easy application of the clear coating layer and strength improvement. The rod diameter is preferably 10-50 mm in terms of coatability. If the rod diameter is smaller than 10 mm, the film-forming ability of starch tends to decrease, resulting in a poor surface appearance.

In the present invention, the coating base paper coated or not coated with a clear coating solution as described above may be precalendered through a chilled calender, soft calender or the like before it is coated with a pigment coating solution.

Precoating (Pigment Coating)

In the present invention, a base paper can also be precoated with a pigment coating solution containing a pigment and an adhesive instead of a clear coating solution to give a coated paper. In the present invention, a coating solution containing a pigment and an adhesive is applied on a base paper made as described above and dried to form a coating layer, and then the coated web is passed through a soft calender to perform smooth finishing, as described below.

In the pigment coating solution based on a pigment and an adhesive, ground calcium carbonate is used as a main pigment component in combination with precipitated calcium carbonate, kaolin, clay, talc, satin white, plastic pigments, titanium dioxide, etc., depending on the required quality. Adhesives used in the pigment coating solution include synthetic adhesives such as emulsions of various copolymers including styrene-butadiene copolymers, styrene-acrylic copolymers, ethylene-vinyl acetate copolymers, etc., and polyvinyl alcohols, maleic anhydride copolymers, etc., as well as oxidized starches, esterified starches, enzyme-modified starches, etherified starches and cold water soluble starches obtained by flash-drying them. The pigment coating solution of the present invention may contain various additives used in conventional pigments for coated paper such as dispersants, thickeners, water retention agents, antifoamers, waterproofing agents, etc.

Especially when a coating solution containing a pigment and an adhesive is applied at 5 g/m² or more in total on both sides by using a rod metering size press (RMSP) type coater in the present invention, a rod metering size press type coater including two applicator rolls having a cover material of type A durometer hardness of 89 or more as defined in JISK6253 is preferably used to prevent abrasion by pigments. The rod of the coater preferably has a groove of 0.30 mm or less in width or does not have a groove (plain rod) to prevent abrasion of applicator rolls by the rod. Especially, grooved rods of even 0.05-0.30 mm can prevent roll abrasion. The rod diameter is preferably 10-50 mm in terms of coatability.

In the present invention, coated papers having a good sheet appearance can be obtained by including 50 parts by weight or more of calcium carbonate per 100 parts by weight of the pigment. Calcium carbonate having a mean particle size of 0.1 μm or more and 0.8 μm or less is desirably used to prevent damage to applicator rolls and improve sheet appearance. In terms of high-speed coatability, ground calcium carbonate is preferably used.

In the present invention, high water retention can be conferred on the coating to reduce penetration of the coating and improve surface quality by using 10 parts by weight or more of starches such as oxidized starches, cationized starches, urea phosphate-esterified starches, hydroxyethyl etherified starches or other etherified starches, or dextrin per 100 parts by weight of the pigment. Especially preferred starches include oxidized starches, urea phosphate-esterified starches, and hydroxyethyl etherified starches.

Coated papers with good surface quality and low tendency of roughening can be obtained by using a coating solution containing a pigment and an adhesive at a coating mass of 5 g/m² or more in total on both sides. The coating mass is preferably 5 g/m²-25 g/m², more preferably 5 g/m²-20 g/m² in total on both sides because if a high-concentration coating is applied to increase the coating mass, the coating solution remains unleveled but the smoothness of the coating surface rather decreases.

In the present invention, the quality of coated paper such as surface quality can be further improved by applying a top coating solution containing a pigment and an adhesive after a coating solution containing a pigment and an adhesive is applied at 5 g/m² or more in total on both sides on a base paper by using a rod metering size press type coater. In cases of a single pigment coating layer, the precoating layer may constitute the outermost one of the pigment coating layers without applying a top coating layer.

The coating mass of the pigment precoating solution is preferably in a range of 1-12 g/m² based on solids per side of a base paper on both sides, more preferably 1-10 g/m², still more preferably 2-8g/m², most preferably 2-5 g/m². Coating masses of less than 1 g/m² are difficult to apply, and if the concentration of the coating solution is lowered, the coating solution significantly penetrates into the base paper, resulting in surface quality loss. If the coating mass is more than 12 g/m², the concentration of the coating solution must be increased, which makes it difficult to control the coating mass for reasons of equipment.

The coated web dried after coating may be precalendered through a chilled calender, soft calender or the like before it is coated with a pigment top coating solution.

Coating Process

In the present invention, a pigment coating solution containing a pigment and an adhesive is applied as a top coating on the coating base paper precoated with a clear coating solution or the base paper precoated with a pigment coating solution containing a pigment and an adhesive instead of the clear coating solution as described above to prepare a coated paper.

The pigment used in the coating solution forming the outermost surface of the coated paper of the present invention can be those used in the conventional coated paper manufacturing field as appropriate. Specifically, kaolin, clay, calcined kaolin, amorphous silica, zinc oxide, aluminum oxide, calcium carbonate, satin white, aluminum silicate, magnesium silicate, magnesium carbonate, plastic pigments, etc. are used alone or optionally as a mixture of two or more of them depending on the quality characteristics of the final product.

The adhesive used in the coating solution can be those used in the conventional coated paper manufacturing field as appropriate, e.g., starches such as native or oxidized starches; proteins such as casein, soybean protein and synthetic proteins; polyvinyl alcohol; cellulose derivatives such as carboxymethyl cellulose and methyl cellulose; conjugated diene polymer latexes such as styrene-butadiene copolymers, methyl methacrylate-butadiene copolymers; acrylic polymer latexes; vinyl polymer latexes such as ethylene-vinyl acetate copolymers, which may be used alone or as a combination of two or more of them. The proportions of the adhesives are adjusted at 5-50 parts by weight, more preferably 10-30 parts by weight per 100 parts by weight of the pigment.

In addition to the pigments and adhesives, the coating solution may also optionally contain various additives used in the conventional coated paper manufacturing field such as dispersants, thickeners, antifoamers, colorants, antistatic agents, preservatives, etc.

The coating solution prepared by using the materials described above is applied on one side or both sides of a base paper optionally precoated with a pigment coating solution containing a pigment and an adhesive to improve surface quality using a blade coater, bar coater, roll coater, air knife coater, reverse roll coater, curtain coater, rod metering size press coater, blade metering size press coater, gate roll coater, spray coater, flooded nip blade coater, jet fountain blade coater, short dwell time applicator blade coater, or the like, and dried. Especially from the aspect of high-speed coatability, jet fountain blade coaters are preferably adopted. The solids content of the coating solution is adjusted to about 30-68% by weight.

Advantages of the present invention are more remarkable when the coating mass is preferably 3-15 g/m², more preferably 4-12 g/m², still more preferably 4-10 g/m² per side of the outermost layer.

Soft Calendering

In the present invention, the paper prepared or coated as described above is surface-treated by soft calendering. We accomplished the present invention on the basis of the finding that coated papers with good sheet gloss and surface quality and high ink adhesion can be prepared without affecting runnability by defining the hardness of the elastic roll and the metallic roll temperature at the first nip in a specific range during soft calendering. In the present invention, the outermost surface of the coated web is surface-treated by using a soft calender comprising a metallic roll and an elastic roll with at least two or more nips, wherein the elastic roll has Shore hardness of D90-96, and the metallic roll surface temperature at the first nip is less than 130° C.

The metallic roll surface temperature at the first nip of the soft calender in the present invention is relatively low, such as less than 130° C., preferably 50° C. or more and less than 130° C., more preferably 60-120° C., still more preferably 60-110° C. If the metallic roll surface temperature at the first nip of the soft calender is higher than 130° C., gloss micro-unevenness will be more likely to occur. In the present invention, an especially preferable metallic roll surface temperature at the first nip of the soft calender is 50° C. or more because sheet gloss increases. The metallic roll surface temperature at the second to sixth nips is preferably 100-250° C., more preferably 100-200° C. The calender nip pressure at the first to sixth nips is preferably 100-600 kN/m, more preferably 150-400 kN/m.

The material of the elastic roll used as a pair with the metallic roll in the soft calender is not specifically limited, but a resin roll showing durability at high temperatures and high pressures is preferably used such as modified urethane resins, epoxy resins, polyamide resins, phenol resins, polyether resins, polyacrylate resins, etc. A satisfactory runnability can be achieved by using a resin roll of Shore hardness of D90-96, preferably D92-96.

The soft calender used in the present invention is a tandem type preferably comprising 4-8 stacks, more preferably 6 stacks of 2 rolls in terms of the ease of paper feeding and space-saving. The tandem type refers to a type of soft calender comprising parallel stacks of two rolls, i.e. a pair of a metallic roll and an elastic roll, preferably operating on-line from the coating step.

The reason why excellent coated papers can be obtained by defining the hardness of the elastic roll and the temperature of the metallic roll at the first nip within a specific range during soft calendering in the present invention is not explained in detail, but it may pertain to the fact that the first nip greatly influences sheet gloss and smoothness while it is susceptible to uneven thickness and uneven moisture of the coating layer of the coated web so that it is the most likely origin of gloss micro-unevenness because the web is treated at the highest moisture at the first nip during high-speed hot soft calendering and therefore its surface is more readily plasticized than at the subsequent nips.

Operating Speed

The present invention relates to a process for preparing a coated paper comprising making a base paper, applying a coating solution containing a pigment and an adhesive on the base paper to form one or more coating layers followed by soft calendering, wherein a coated web is obtained in the papermaking and coating steps at an operating speed of 1300 m/min or more, and then the outermost surface of the coated web is soft calendered under specific conditions, or preferably a process for preparing a coated paper comprising making a base paper, applying a coating solution containing a pigment and an adhesive on the base paper to form one or more coating layers followed by soft calendering, wherein the operating speed is 1300 m/min or more. The present invention allows for preparation of coated printing papers having a good surface appearance including low gloss micro-unevenness and low ink adhesion unevenness with good runnability at high-speed of 1300 m/min or more. The operating speed in the present invention is preferably 1500 m/min or more, more preferably 1600 m/min or more, and the present invention can be applied to operations at e.g., 1800 m/min, or even about 2500 m/min. Especially, the advantage of solving the problems of runnability and gloss micro-unevenness in coated papers provided by the present invention can be preferably enjoyed to a greater extent by feeding a web on-line through a series of continuous papermaking, coating and calendering steps to give a coated paper.

In the present invention, coated papers having a good surface appearance including low gloss micro-unevenness and low ink adhesion unevenness can be prepared with good high-speed runnability, and especially greater benefits can be offered to light-weight coated papers by a process for preparing a coated paper at a high speed of 1300 m/min or more, comprising continuously performing the steps of applying a coating solution containing a pigment and an adhesive on a base paper made by using a gap former type paper machine including a shoe press in the press part and drying it to form one or more coating layers, and then finishing a coated paper by a surface treatment with a soft calender.

In the present invention, advantages of the present invention are more remarkable when the basis weight of the coated paper is preferably 30-80 g/m², more preferably 40-65 g/m².

### EXAMPLES

The following examples further illustrate the present invention. The parts and % in the examples mean parts by weight and % by weight, respectively. Quality evaluation methods are shown below.

### Experimental Example 1

### <Quality Evaluation Methods>

### (1) Sheet Gloss

Sheet gloss was determined at an angle of 75° according to JIS P-8142.

### (2) High-Speed Runnability

Runnability during high-speed operation was evaluated according to the 4-class scale below on the basis of resistance to web breaks in the press part, resistance to mist generation during coating, resistance to shrinkage-induced wrinkles during calendering, and high durability of elastic rolls: ⊚: very good, ◯: good, Δ: slightly poor, ×: poor.

### (3) Gloss Micro-Unevenness

Gloss micro-unevenness in the final product was evaluated according to the 4-class scale below: ⊚: none, ◯: negligible, Δ: slightly visible, ×: highly prominent.

### (4) Ink Adhesion Unevenness

Printing was performed using printing inks (Hy-Unity M from Toyo Ink Mfg. Co., Ltd.) in the order of cyan→magenta→yellow→black in a Roland lithographic press (4-color) at a printing speed of 8000 sheets/min, and the resulting print was visually evaluated according to the 4-class scale below for print appearance (ink adhesion unevenness, gloss unevenness, etc.) especially in the solid print area and halftone (50%) print area in two colors (cyan, magenta) and cyan alone: ⊚: very good, ◯: good, Δ: slightly poor, ×: poor.

### Example 1

To a pulp slurry consisting of 30 parts of waste paper pulp and 70 parts of LBKP were added precipitated calcium carbonate as a filler to an ash content in paper of 11% and 3 parts of a cationized starch as an internal paper strength enhancer to prepare a stock.

This stock was used in a roll and blade gap former type paper machine at a machine speed of 1600 m/min including two tandem shoe presses in the press part (at a nip pressure 1000 kN/m in such a manner that the transfer belt comes into contact with the wire side of paper on the second shoe press) to drain the wet web into a dry base paper, which was then coated with an oxidized starch solution having a solids content of 6% at 1.6 g/m² in total on both sides using an on-machine rod metering size press coater and dried to give a mechanical coating base paper of 45.6 g/m².

Then, 4.5 parts of an oxidized starch and 8.2 parts of a carboxyl-modified styrene-butadiene copolymer latex were added as adhesives per 100 parts of a pigment containing 73 parts of ground calcium carbonate and 27 parts of kaolin to prepare a coating solution having a solids content of 64% and the base paper was coated with the coating solution on both sides at a coating mass of 8.3 g/m² per side using a jet fountain type blade coater and dried.

Subsequently, the coated web was surface-treated in a finishing step using a soft calender comprising 6 stacks of 2 rolls including an elastic roll of Shore hardness of D94. It was continuously calendered at a metallic roll surface temperature of 120° C. at the first nip, a metallic roll surface temperature of 130° C. at the second to sixth nips, and a nip pressure of 250 kN/m at the first to sixth nips.

The papermaking, coating and calendering steps took place continuously, so that the coating and calendering speeds were also 1600 m/min.

### Example 2

A coated paper was prepared exactly in the same manner as described above in Example 1 except that the metallic roll surface temperature at the first nip was changed to 60° C. in the finishing step.

### Example 3

A coated paper was prepared exactly in the same manner as described above in Example 1 except that the metallic roll surface temperature at the first nip was changed to 30° C. in the finishing step.

### Comparative Example 1

A coated paper was prepared exactly in the same manner as described above in Example 1 except that an elastic roll of Shore hardness of D88 was used in the finishing step.

### Comparative Example 2

A coated paper was prepared exactly in the same manner as described above in Example 1 except that an elastic roll of Shore hardness of D98 was used in the finishing step.

### Comparative Example 3

A coated paper was prepared exactly in the same manner as described above in Example 1 except that the metallic roll surface temperature at the first nip was changed to 140° C. in the finishing step.

TABLE 1

| | | | Finishing step | | | Quality | | |
|---|---|---|---|---|---|---|---|---|
| | | | Elastic roll | Temperature | | | Gloss | Ink |
| | | | hardness | at the first | | Sheet | micro- | adhesion |
| | Wire step | Press step | Shore D | nip ° C. | Runnability | gloss | unevenness | unevenness |
| Example 1 | Gap former | 1P, 2P shoe press | 94 | 120 | ⊚ | 52 | ◯ | ◯ |
| Example 2 | Gap former | 1P, 2P shoe press | 94 | 60 | ⊚ | 50 | ⊚ | ⊚ |
| Example 3 | Gap former | 1P, 2P shoe press | 94 | 30 | ⊚ | 45 | ⊚ | ⊚ |
| Comparative example 1 | Gap former | 1P, 2P shoe press | 88 | 120 | X | 52 | ⊚ | ⊚ |
| Comparative example 2 | Gap former | 1P, 2P shoe press | 98 | 120 | ⊚ | 53 | X | X |
| Comparative example 3 | Gap former | 1P, 2P shoe press | 94 | 140 | ⊚ | 55 | X | X |

The results are shown in Table 1. As shown in Table 1, the coated papers prepared according to the present invention showed good high-speed runnability as well as good results in sheet gloss, gloss micro-unevenness, and ink adhesion unevenness (Examples 1-3). Moreover, Examples 1 and 2 performed at metallic roll temperatures of 50° C.-130° C. at the first nip of the soft calender showed better sheet gloss as compared with Example 3 performed at a metallic roll temperature of 30° C.

However, Comparative example 1 using a soft calender including an elastic roll of hardness of D88 was poor in high-speed runnability, and Comparative example 2 using an elastic roll of hardness of D98 showed considerable gloss micro-unevenness and ink adhesion unevenness. Comparative example 3 performed at a high metallic roll temperature of 140° C. at the first nip of the soft calender was good in high-speed runnability, but showed considerable gloss micro-unevenness and ink adhesion unevenness on the surface of the coated paper.

### Experimental Example 2

### <Quality Evaluation Methods>

### (1) Mean Particle Size of the Pigment

The mean particle size was determined as the D50 value of the cumulative volume-weighted size distribution using a laser diffraction/scattering particle size distribution analyzer (Mastersizer S from Malvern).

### (2) Surface State of Applicator Rolls

After coating for 24 hours, the surfaces of applicator rolls before and after coating were visually compared. ⊚: same as before coating, ◯: approximately same as before coating, Δ: slightly deteriorated, ×: greatly deteriorated.

### (3) Sheet Appearance of Coated Paper

Irregularities and gloss micro-unevenness on the sheet surface of coated paper were visually evaluated. ⊚: very good, ◯: good, Δ: slightly poor, ×: poor.

### (4) Surface Quality of Coated Paper

The surface quality of coated paper was evaluated according to the surface roughness and smoothness test method (air leak method) as defined in JIS P 8151—Print-Surf tester method. A hard backing was used and the clamp pressure was 980 kPa. Surface quality was determined as an average of F (felt side)/W (wire side).

### (5) Blister Resistance

Printing was performed on both sides of a specimen using an offset printing ink (TK Mark V617 from Toyo Ink Mfg. Co., Ltd.) at a constant ink volume of 0.8 cc in an RI-I printer (from Akira Seisakusho) and the specimen was conditioned to a specific humidity all day and night, and then immersed in an oil bath controlled at a temperature of 140° C. and visually tested for blistering. ⊚: none, ◯: negligible, Δ: visible, ×: prominent.

### Example 4

To a pulp slurry consisting of 70 parts of LBKP and 30 parts of DIP (containing 35% by weight of TMP) were added precipitated calcium carbonate as a filler to an ash content in paper of 11% and 0.4 parts of a cationized starch as an internal paper strength enhancer to prepare a stock.

This stock was used to make a paper in a roll and blade gap former type paper machine including two tandem shoe presses at 1600 m/min.

Subsequently, the resulting web was precoated with a coating solution at a solids content of 46% containing 15 parts of an oxidized starch and 2 parts of a carboxyl-modified styrene-butadiene copolymer latex as adhesives per 100 parts of ground calcium carbonate having a mean particle size of 0.64 μm at 6 g/m² in total on both sides using an on-machine rod metering size press coater including two applicator rolls having a cover material of type A durometer hardness of 90 and an ungrooved rod (rod diameter 25 min) provided on each roll, and dried to give a precoated web having a basis weight of 50 g/m².

Then, a coating solution at a solids content of 64% containing 7 parts of an oxidized starch and 8 parts of a carboxyl-modified styrene-butadiene copolymer latex as adhesives per 100 parts of ground calcium carbonate was applied to form a pigment coating layer as a top coating on both sides at 8 g/m² per side at a coating speed of 1600 m/min using a blade type coater, and dried.

Subsequently, the coated web was surface-treated in a finishing step using a soft calender comprising 6 stacks of 2 rolls including an elastic roll of Shore hardness of D94. It was calendered at a metallic roll surface temperature of 60° C. at the first nip, a metallic roll surface temperature of 130° C. at the second to sixth nips, and a nip pressure of 250 kN/m at the first to sixth nips to give a coated paper for offset printing.

The papermaking, coating and calendering steps took place continuously, so that the coating and calendering speeds were also 1600 m/min.

### Example 5

A coated paper for offset printing was obtained in the same manner as described above in Example 4 except that a coating solution at a solids content of 40% containing 15 parts of an oxidized starch and 2 parts of a carboxyl-modified styrene-butadiene copolymer latex as adhesives per 100 parts of ground calcium carbonate having a mean particle size of 0.64 μm was applied at 6g/m² in total on both sides using a rod metering size press including a rod having a groove of 0.10 mm in width instead of the ungrooved rod and in Example 4.

### Comparative Example 4

A coated paper for offset printing was obtained in the same manner as described above in Example 4 except that the metallic roll surface temperature at the first nip was changed to 140° C. in the finishing step in Example 4.

### Comparative Example 5

A coated paper for offset printing was obtained in the same manner as described above in Comparative example 4 except that an on-machine rod metering size press including two applicator rolls having a cover material of type A durometer hardness of 84 as defined in JISK6253 was used instead of the on-machine rod metering size press including two applicator rolls having a cover material of type A durometer hardness of 90 as defined in JISK6253 in Comparative example 4.

TABLE 2

| | Rod metering size press (precoating) coating | | | | | Pigment | | | Applicator | | | Ink |
|---|---|---|---|---|---|---|---|---|---|---|---|---|
| | | | | | Coating | Coating | Finishing step | | roll | | Gloss | ad- |
| | Applicator | | | | mass on | mass | Elastic | | surface | | micro- | hesion |
| | roll type A | Rod | Pigment | | both | per | roll | Temperature | state | | un- | un- |
| | durometer | (groove | (particle | | sides | side | hardness | at the | after | Runna- | even- | even- |
| | hardness | width) | size) | Adhesive | g/m² | g/m² | Shore D | first nip ° C. | 24 hours | bility | ness | ness |
| Example 4 | 90 | Ungrooved | 100 parts | 15 parts | 6 | 8 | 94 | 60 | ⊚ | ⊚ | ⊚ | ⊚ |
| | | | calcium | oxidized | | | | | | | | |
| | | | carbonate | starch/ | | | | | | | | |
| | | | (0.64 μm) | 2 parts | | | | | | | | |
| | | | | latex | | | | | | | | |
| Example 5 | 90 | Grooved | 100 parts | 15 parts | 6 | 8 | 94 | 60 | ⊚ | ⊚ | ⊚ | ⊚ |
| | | (0.1 mm) | calcium | oxidized | | | | | | | | |
| | | | carbonate | starch/ | | | | | | | | |
| | | | (0.64 μm) | 2 parts | | | | | | | | |
| | | | | latex | | | | | | | | |
| Comparative | 90 | Ungrooved | 100 parts | 15 parts | 6 | 8 | 94 | 140 | ⊚ | ⊚ | Δ | Δ |
| example 4 | | | calcium | oxidized | | | | | | | | |
| | | | carbonate | starch/ | | | | | | | | |
| | | | (0.64 μm) | 2 parts | | | | | | | | |
| | | | | latex | | | | | | | | |
| Comparative | 84 | Ungrooved | 100 parts | 15 parts | 6 | 8 | 94 | 140 | Δ | X | Δ | Δ |
| example 5 | | | calcium | oxidized | | | | | | | | |
| | | | carbonate | starch/ | | | | | | | | |
| | | | (0.64 μm) | 2 parts | | | | | | | | |
| | | | | latex | | | | | | | | |

As shown in Table 2, the coated printing papers of Examples 4 and 5 showed good surface states of applicator rolls, neither gloss micro-unevenness nor ink adhesion unevenness, and good sheet appearance and surface quality of the coated papers as well as good runnability. However, Comparative example 4 was poor in the sheet appearance, ink adhesion unevenness and gloss micro-unevenness in the coated paper. Comparative example 5 showed worse surface state of applicator rolls than before coating, deteriorated sheet appearance and surface quality in the coated paper as well as poor ink adhesion unevenness and gloss micro-unevenness.

### Example 6

To a pulp slurry consisting of 70 parts of LBKP and 30 parts of DIP (containing 35% by weight of TMP) were added precipitated calcium carbonate as a filler to an ash content in paper of 11% and 0.4 parts of a cationized starch as an internal paper strength enhancer to prepare a stock.

This stock was used to make a paper in a roll and blade gap former type paper machine including two tandem shoe presses at 1600 m/min, and the resulting web was then coated with a coating solution at a solids content of 57% containing 13 parts of an oxidized starch and 4 parts of a carboxyl-modified styrene-butadiene copolymer latex as adhesives per 55 parts of ground calcium carbonate having a mean particle size of 0.64 μm and 45 parts of clay having a mean particle size of 0.4 μm at 15 g/m² in total on both sides using an on-machine rod metering size press coater including two applicator rolls having a cover material of type A durometer hardness of 90 as defined in JISK6253 and an ungrooved rod (rod diameter 25 mm) provided on each roll, and dried.

Subsequently, the coated web was surface-treated in a finishing step using a soft calender comprising 6 stacks of 2 rolls including an elastic roll of Shore hardness of D94. It was calendered at a metallic roll surface temperature of 60° C. at the first nip, a metallic roll surface temperature of 130° C. at the second to sixth nips, and a nip pressure of 250 kN/m at the first to sixth nips to give a coated paper for offset printing having a basis weight of 70 g/m². The papermaking, coating and calendering steps took place continuously, so that the coating and calendering speeds were also 1600 m/min.

### Example 7

A coated paper for offset printing was obtained in the same manner as described above in Example 6 except that a coating solution at a solids content of 53% containing 13 parts of an oxidized starch and 4 parts of a carboxyl-modified styrene-butadiene copolymer latex as adhesives per 55 parts of ground calcium carbonate having a mean particle size of 0.64 μm and 45 parts of clay having a mean particle size of 0.4 μm was applied at 15 g/m² in total on both sides using a rod metering size press including a rod having a groove of 0.10 mm in width instead of the ungrooved rod, and dried in Example 6.

### Comparative Example 6

A coated paper for offset printing was obtained in the same manner as described above in Example 6 except that the metallic roll surface temperature at the first nip was changed to 1.40° C. in the finishing step in Example 6.

### Comparative Example 7

A coated paper for offset printing was obtained in the same manner as described above in Comparative example 6 except that an on-machine rod metering size press including two applicator rolls having a cover material of type A durometer hardness of 84 as defined in JISK6253 was used instead of the on-machine rod metering size press including two applicator rolls having a cover material of type A durometer hardness of 90 as defined in JISK6253 in Comparative example 6.

TABLE 3

| | Rod metering size press (precoating) | | | | | | | | | | |
|---|---|---|---|---|---|---|---|---|---|---|---|
| | | | | | Coating | Finishing step | | Applicator | | | |
| | Applicator | | | | mass on | Elastic | | roll surface | | Gloss | Ink |
| | roll type A | Rod | | | both | roll | Temperature | state | | micro- | adhesion |
| | durometer | (groove | Pigment | | sides | hardness | at the first | after 24 | Runna- | uneven- | uneven- |
| | hardness | width) | (particle size) | Adhesive | g/m² | Shore D | nip ° C. | hours | bility | ness | ness |
| Example 6 | 90 | Ungrooved | 55 parts | 13 parts | 15 | 94 | 60 | ⊚ | ⊚ | ◯ | ◯ |
| | | | calcium | oxidized | | | | | | | |
| | | | carbonate | starch/ | | | | | | | |
| | | | (0.64 μm)/ | 4 parts | | | | | | | |
| | | | 45 parts clay | latex | | | | | | | |
| | | | (0.4 μm) | | | | | | | | |
| Example 7 | 90 | Grooved | 55 parts | 13 parts | 15 | 94 | 60 | ⊚ | ⊚ | ◯ | ◯ |
| | | (0.1 mm) | calcium | oxidized | | | | | | | |
| | | | carbonate | starch/ | | | | | | | |
| | | | (0.64 μm)/ | 4 parts | | | | | | | |
| | | | 45 parts clay | latex | | | | | | | |
| | | | (0.4 μm) | | | | | | | | |
| Comparative | 90 | Ungrooved | 55 parts | 13 parts | 15 | 94 | 140 | ⊚ | ⊚ | Δ | Δ |
| example 6 | | | calcium | oxidized | | | | | | | |
| | | | carbonate | starch/ | | | | | | | |
| | | | (0.64 μm)/ | 4 parts | | | | | | | |
| | | | 45 parts clay | latex | | | | | | | |
| | | | (0.4 μm) | | | | | | | | |
| Comparative | 84 | Ungrooved | 55 parts | 13 parts | 15 | 94 | 140 | Δ | X | Δ | Δ |
| example 7 | | | calcium | oxidized | | | | | | | |
| | | | carbonate | starch/ | | | | | | | |
| | | | (0.64 μm)/ | 4 parts | | | | | | | |
| | | | 45 parts clay | latex | | | | | | | |
| | | | (0.4 μm) | | | | | | | | |

As shown in Table 3, the coated printing papers of Examples 6 and 7 showed better surface states of applicator rolls, neither gloss micro-unevenness nor ink adhesion unevenness in the coated papers, and better sheet appearance and surface quality of the coated papers, as well as better runnability as compared with Comparative examples 6 and 7. However, Comparative example 6 was poor in the sheet appearance, ink adhesion unevenness and gloss micro-unevenness in the coated paper. Comparative example 7 showed worse surface state of applicator rolls than before coating, deteriorated sheet appearance and surface quality in the coated paper as well as poor ink adhesion unevenness and gloss micro-unevenness.

### Experimental Example 3

### <Quality Evaluation Methods>

### (1) High-Speed Runnability

High-speed runnability was evaluated on the basis of resistance to mist generation during coating and low dry load. ⊚: very good, ◯: good, Δ: slightly poor, ×: poor.

### (2) Blister Resistance

Printing was performed on both sides of a specimen using an offset printing ink (TK Mark V617 from Toyo Ink Mfg. Co., Ltd.) at a constant ink volume of 0.8 cc in an RI-I printer (from Akira Seisakusho) and the specimen was conditioned to a specific humidity all day and night, and then immersed in an oil bath controlled at a temperature of 140° C. and visually tested for blistering. ⊚: none, ◯: negligible, Δ: visible, ×: prominent.

### Example 8

To a pulp slurry consisting of 70 parts of LBKP and 30 parts of DIP (containing 35% by weight of TMP) were added precipitated calcium carbonate as a filler to an ash content in paper of 11% and 4 parts of a cationized starch as an internal paper strength enhancer to prepare a stock. This stock was used to make a paper in a roll and blade gap former type paper machine including two tandem shoe presses at 1700 m/min and the resulting web was then coated with an oxidized starch solution having a solids content of 10% at 1.6 g/m² on both sides using an on-machine rod metering size press including a rod (rod diameter 15 mm) having a groove of 0.10 mm in width and dried to give a coating base paper of 45.6 g/m².

Then, a coating solution at a solids content of 64% containing 4.5 parts of an oxidized starch and 8.2 parts of a carboxyl-modified styrene-butadiene copolymer latex as adhesives per 100 parts of a pigment containing 73 parts of ground calcium carbonate and 27 parts of kaolin was applied to form a top coating on both sides at 8.3 g/m² per side, and dried.

Subsequently, the coated web was surface-treated in a finishing step using a soft calender comprising 6 stacks of 2 rolls including an elastic roll of Shore hardness of D94. It was calendered at a metallic roll surface temperature of 60° C. at the first nip, a metallic roll surface temperature of 130° C. at the second to sixth nips, and a nip pressure of 250 kN/m at the first to sixth nips. The papermaking, coating and calendering steps took place continuously, so that the coating and calendering speeds were also 1700 m/min.

### Example 9

A coated paper was prepared in the same manner as described above in Example 8 except that the oxidized starch was applied at 1.6g/m² using a rod groove width of 0.30 mm instead of the rod groove width of 0.10 mm in Example 8.

### Comparative Example 8

A coated paper was prepared in the same manner as described above in Example 8 except that the metallic roll surface temperature at the first nip was changed to 140° C. in the finishing step in Example 8.

### Comparative Example 9

A coated paper was prepared in the same manner as described above in Comparative example 8 except that the oxidized starch was applied at 1.6 g/m² using a rod groove width of 0.40 mm instead of the rod groove width of 0.10 mm in Comparative example 8.

TABLE 4

| | Rod metering size press (clear coating) | | | Pigment | Finishing step | | | | |
|---|---|---|---|---|---|---|---|---|---|
| | | | Coating mass | coating | Elastic roll | | | Gloss | Ink |
| | Rod | Coating | on both sides | Coating mass | hardness | Temperature at | | micro- | adhesion |
| | (groove width) | material | g/m² | per side g/m² | Shore D | the first nip ° C. | Runnability | unevenness | unevenness |
| Example 8 | Grooved | Oxidized | 1.6 | 8.3 | 94 | 60 | ⊚ | ◯ | ◯ |
| | (0.1 mm) | starch | | | | | | | |
| Example 9 | Grooved | Oxidized | 1.6 | 8.3 | 94 | 60 | ◯ | ◯ | ◯ |
| | (0.3 mm) | starch | | | | | | | |
| Comparative | Grooved | Oxidized | 1.6 | 8.3 | 94 | 140 | ⊚ | Δ | Δ |
| example 8 | (0.1 mm) | starch | | | | | | | |
| Comparative | Grooved | Oxidized | 1.6 | 8.3 | 94 | 140 | X | Δ | Δ |
| example 9 | (0.4 mm) | starch | | | | | | | |

As shown in Table 4, the coated printing papers of the present invention showed negligible mist generation, good high-speed runnability and neither gloss micro-unevenness nor ink adhesion unevenness in the coated papers as well as good blister resistance as compared with Comparative examples 8 and 9. However, Comparative example 8 was poor in gloss micro-unevenness and ink adhesion unevenness in the coated paper. Comparative example 9 showed good blister resistance, but significant mist generation and poor high-speed runnability as well as poor gloss micro-unevenness and ink adhesion unevenness in the coated paper.

1. A process for preparing a coated paper, comprising the steps of:
making a base paper;
applying a coating solution containing a pigment and an adhesive on the base paper to form one or more pigment coating layers; and
surface-treating the pigment coating layers by a soft calender,
said papermaking and coating steps being performed at an operating speed of 1300 m/min or more;
wherein said surface-treating step comprises treating the outermost one of the pigment coating layers using a soft calender comprising a metallic roll and an elastic roll with at least two or more nips, and wherein the elastic roll has a Shore D hardness of 90-96 and the metallic roll surface temperature at the first nip is less than 130° C.

2. The process for preparing a coated paper of claim 1 wherein the metallic roll surface temperature at the first nip of the soft calender is 50° C. or more and less than 130° C.

3. The process for preparing a coated paper of claim 1 wherein the base paper is made by using a gap former type paper machine.

4. The process for preparing a coated paper of claim 1 wherein the metallic roll surface temperature at the second and subsequent nips of the soft calender is 100° C.-250° C.

5. The process for preparing a coated paper of claim 1 wherein the papermaking, coating and calendering steps continuously take place on-line.

6. The process for preparing a coated paper of claim 1, comprising the step of forming a pigment coating layer at 5.0 g/m² or more in total on both sides using a rod metering size press type coater including an applicator roll having a cover material of type A durometer hardness of 89 or more and 95 or less as defined in JISK6253.

7. The process for preparing a coated paper of claim 1, comprising the step of forming a clear coating layer containing an adhesive at 0.5 g/m² or more in total on both sides using a rod metering size press type coater having a grooved rod of 0.30 mm or less in groove width or an ungrooved rod.
